(19) United States
(12) Patent Application Publication
(10) Pub. No.: US 2005/0184115 A1
(43) Pub. Date: Aug. 25, 2005

(54) Inside the belt quick release holster

(76) Inventor: George Wells, Atlanta, GA (US)

Correspondence Address: Philip H. Burrus, IV, 460 Grant Street, Atlanta, GA, 30312, US

(21) Appl. No.: 10/783,142

(22) Filed: Feb. 23, 2004

(51) Int. Cl. A01K 97/10; A45C 1/04

(52) U.S. Cl. 224/193

(57) ABSTRACT

A quick release holster assembly for carrying an object like a firearm is provided. The holster is preferably worn inside the trousers. A holding member for receiving a firearm is coupled to a planar member capable of actuating in a cantilever fashion. A pair of retaining members extend from the planar member towards the holding member. The holding member, the retaining members and the planar member form a closed loop, as the planar member is preferably preloaded such that at least one of the retaining members makes contact with the holding member. The retaining members extend in an essentially perpendicular fashion from the planar member, and include frictional members, like a rubber grommet for example, that allows the holster to “cling” to the user. TO put the holster, the user slides the holding member between his or her torso and the waistband of the trousers. The user then gently pulls the planar member away from the holding member, thereby separating the retaining members from the holding member, which allows a belt to slide between the retaining members and the holding member. The invention offers a quickly releasable, easily concealable holster.

### BACKGROUND

1. Field of the Invention

This invention relates generally to holsters having clips for accommodating a belt, and more specifically to a holster for a firearm or other object to be worn inside the pants, wherein the holster has a quick release mechanism so as to be easily coupled to, and decoupled from, the belt.

2. Background Art

Sometimes it may seem as if the world today is an unsafe place. Despite the excellent efforts of our heroic law enforcement personnel and the strict sentencing guidelines for violent criminals, terrorism, school shootings and domestic violence persist. As a result, more and more law-abiding citizens are applying for weapon permits. With proper training and faithful consideration of safety rules, many people today feel that a personal firearm offers an additional source of protection in the event that a dangerous situation arises.

Weapons, like handguns for instance, are carried in several different places. For example, women who carry a purse often choose to carry a small handgun therein. Specialty clothing may include secret compartments specially designed for carrying weapons as well. By far the most popular way to carry a weapon, however, is with a holster. This is the popular choice of law enforcement and citizenry alike.

Many holsters available on the market today may be worn on the belt. One such holster is shown in FIG. 1. The holster 1 includes a pocket 2 for holding a weapon, as well as a latch 3, like a snap for example, which prevents the weapon from falling out of the holster. The holster couples to a belt by way of holes 4,5. The holes 4,5 serve as the openings of an effective tube formed by the front and rear pieces of leather. A user slips a belt through this tube while lacing the belt through the belt loops on a pair of trousers. Once the belt is buckled, the holster is secured on the user's person.

The problem with this holster, however, is that it must be worn on the outside of the belt. As such, unless the user wears a jacket or other bulky garment to cover the holster, the exposed firearm may appear menacing to everyday passers by. Additionally, a holster worn on the outside of the belt may encourage a criminal to try and “swipe” the gun so as to gain access to a weapon.

For these reasons, more than 30 states have passed laws that permit people to carry concealed weapons. A popular way to carry a concealed weapon is by a holster that fits inside the belt rather than outside. Such a holster is shown in FIG. 2. This holster 20 includes a springy metal clip 21 with a notch 22. To attach the holster 20 to a belt, one must pry the metal clip 21 away from the holster 20. This is accomplished by placing a finger on the finger ridge 24 and pulling the metal clip 21 out from the holster 20, thereby causing the metal curve 25 to deform. Once a belt is inserted under the clip 21, the user releases the metal clip 21, thereby allowing it to snap back such that the notch 22 falls within a recess 23.

The problem with this prior art holster is two fold: First, metal latches are often stiff and hard to move. When one tries to grasp the finger ridge 24, it is often easy to break a nail. Furthermore, many of these holsters are made from soft cloth, which fails to provide an opposing force against which the clip 21 can be levered.

Second, even when a user does manage to pry the metal clip 21 up, they must lift the clip not only far enough to pass over the belt, but they must lift it far enough to escape the recess 23 as well. In other words, the metal clip 21 must first be lifted at least as high as the recess 23 is deep, and then must additionally be lifted over the belt. All this lifting makes the prior art holster very difficult to take off.

There is thus a need for an improved holster capable of being worn inside the pants that it quickly and easily releasable.

### BRIEF DESCRIPTION OF THE DRAWINGS

FIG. 1 illustrates a prior art holster.

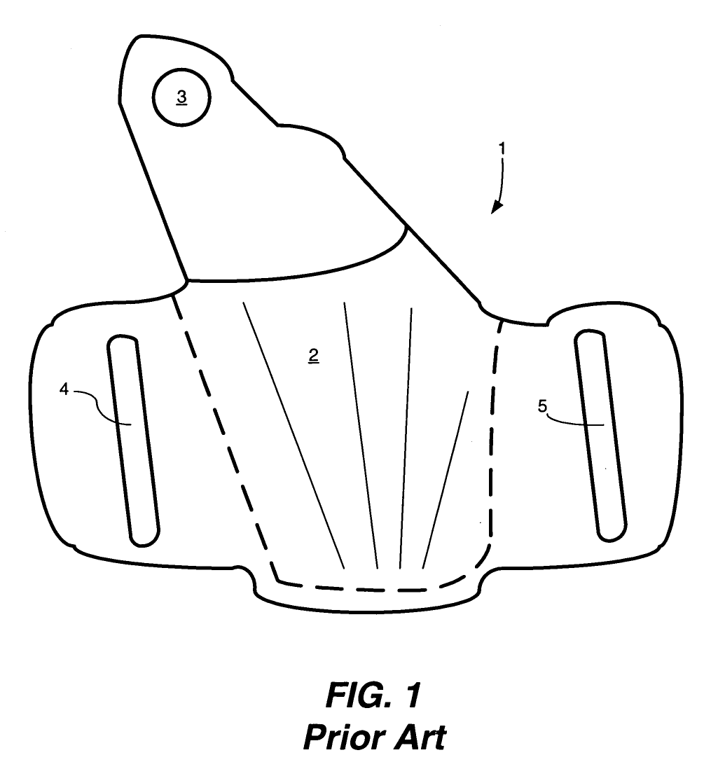

FIG. 2 illustrates a prior art holster.

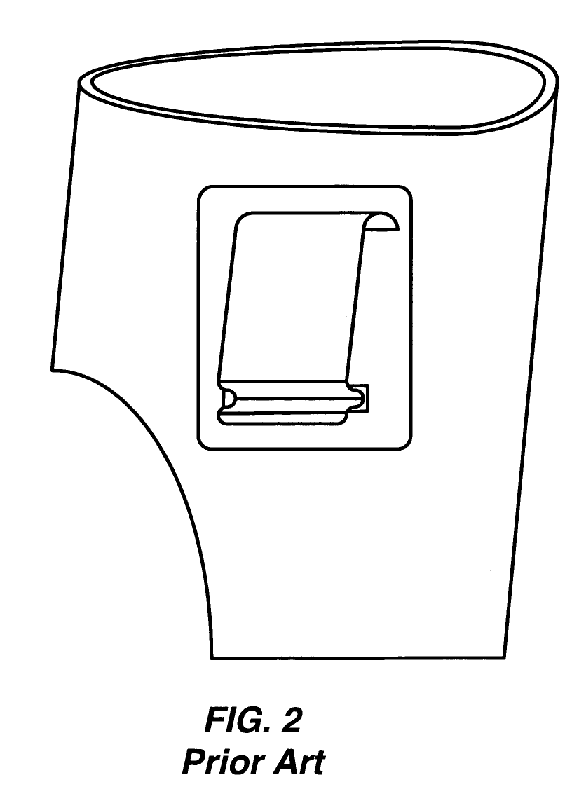

FIG. 3 illustrates a perspective view of one preferred embodiment of a holster in accordance with the invention.

FIG. 4 illustrates a right, elevation view of one preferred embodiment of a holster in accordance with the invention.

FIG. 5 illustrates a rear, elevation view of one preferred embodiment of a holster in accordance with the invention.

FIG. 6 illustrates a left, elevation view of one preferred embodiment of a holster in accordance with the invention.

FIG. 7 illustrates a front, elevation view of one preferred embodiment of a holster in accordance with the invention.

FIG. 8 illustrates a top, plan view of one preferred embodiment of a holster in accordance with the invention.

FIG. 9 illustrates a bottom, plan view of one preferred embodiment of a holster in accordance with the invention.

FIG. 10 illustrates one preferred embodiment of the invention in use with a firearm and belt.

### DETAILED DESCRIPTION OF A PREFERRED EMBODIMENT

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

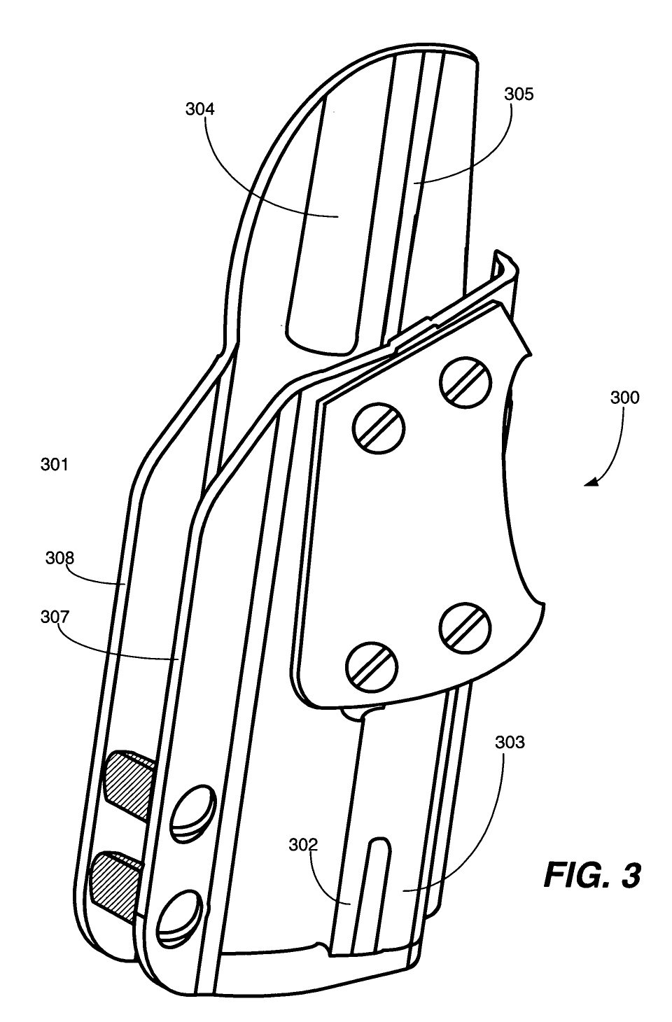

Referring now to FIG. 3, illustrated therein is one preferred embodiment of a holster assembly 300 in accordance with the invention. The terms “holster assembly” and “holster” will be used interchangeably herein. The holster assembly 300 includes a holding member 301 that essentially forms a semi-flexible pocket into which an object, like a handgun for example, may be placed. The holding member 301 is preferably manufactured from plastic, and may be constructed from any number of materials, including plastics like Styrene, ABS, polycarbonate, and ABS-polycarbonate. Other materials, including leather, cloth, and vinyl may also be used, but a semi-rigid, semi-flexible plastic is preferred. Experimental testing has shown that Kydex®, a plastic manufactured by the Kleerdex Company of Aiken, S.C., performs well in that it is reasonably flexible, resilient, durable and easily molded.

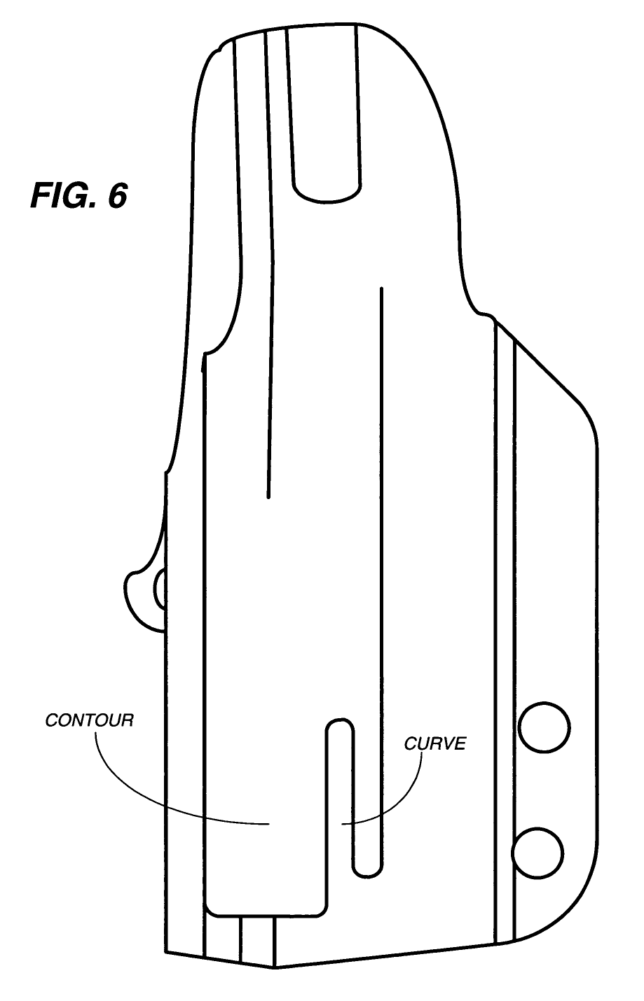

The holding member 301 is preferably formed from a single piece of plastic, either by thermal forming or injection molding. The holding member 301 includes curves 302,303 and contours, 304,305, designed to be the geometric compliment of the object that is to be placed in the holding member 301. These curves and contours may also be seen in FIG. 6.

By way of example, if the object to be placed in the holding member 301 is a Model 19 pistol manufactured by the Glock Corporation, the curves 302,303 and contours 304,305 would be complementary to the configuration of the outers sections of the Model 19 pistol. For instance, curve 302 would be complimentary to the base member of the pistol that supports the slide, while contour 304 would be complimentary to the slide itself.

As noted above, the holding member 301 is preferably manufactured from a single piece of material. One preferred method of manufacture for the holding member 301 is by way of thermal forming. In the thermal forming process, the plastic is heated slightly to become soft and pliable. The sides 307,308 of the holding member 301 are then molded about a positive mold having contours matching the object. Another equivalent method of manufacture is injection molding, in which the material is injected—in molten form—into a mold, the interior of which is shaped to be a positive of the object. In either case, the holding member 301 is molded such that the interior of the formed “U-Shape” is such that the interior forms the negative image of the firearm.

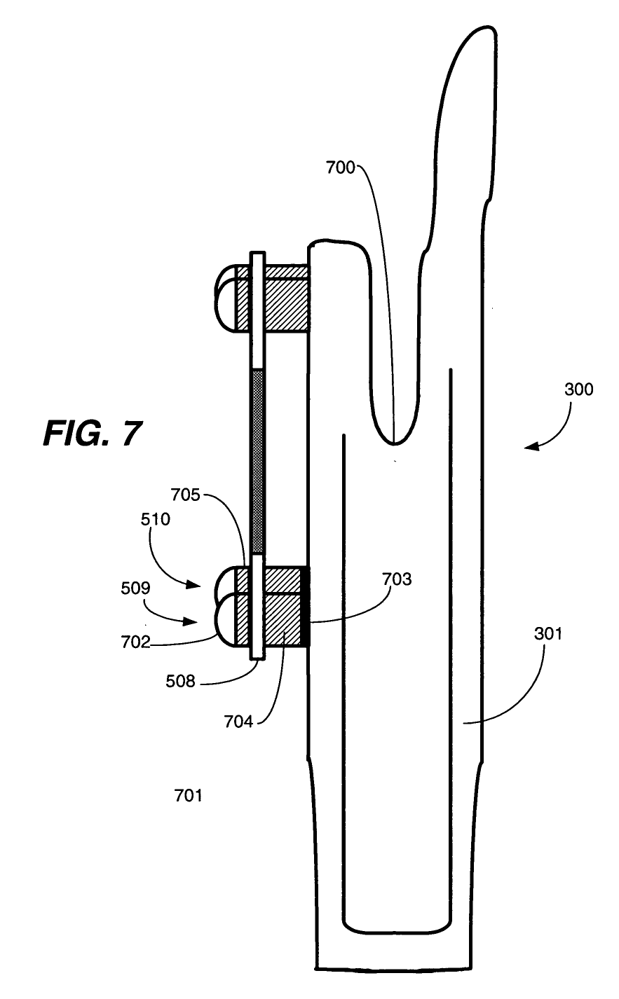

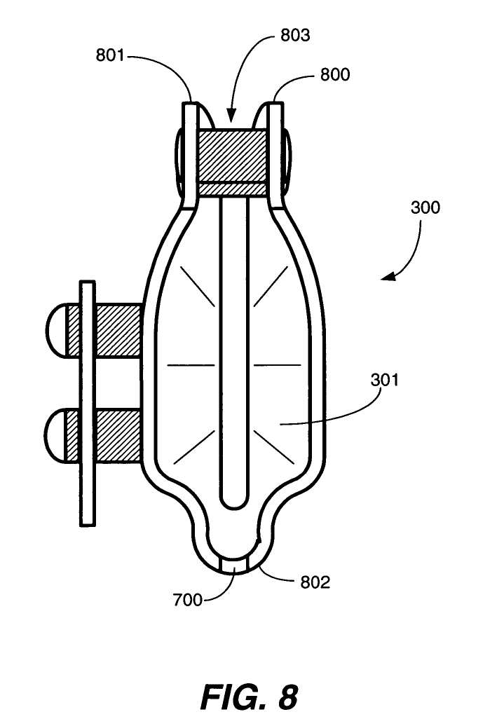

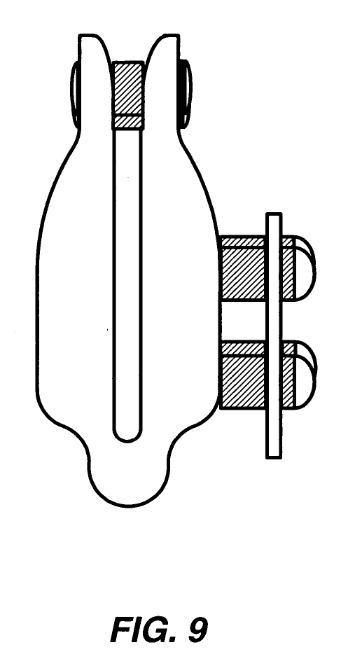

Referring now to FIG. 8, illustrated therein is a top, plan view of the holster 300 that better illustrates the “U” shape. As shown in FIG. 8, the holding member 301 is molded so as to form a “U” shape, with the curved or closed portion of the “U” running along the front edge 802 of the holding member in which a notch aperture (element 700 of FIG. 7) is located. The open portion 803 of the “U” runs along the rear of the holding member 301. The open portion 803 of the “U” accommodates the trigger guard of the firearm. The holding member 301 may also include first and second guard members 800,801 for preventing objects from coming into contact with the trigger and trigger guard of the firearm. The open and closed portions of the “U” may be seen in the bottom, plan view of FIG. 9 as well.

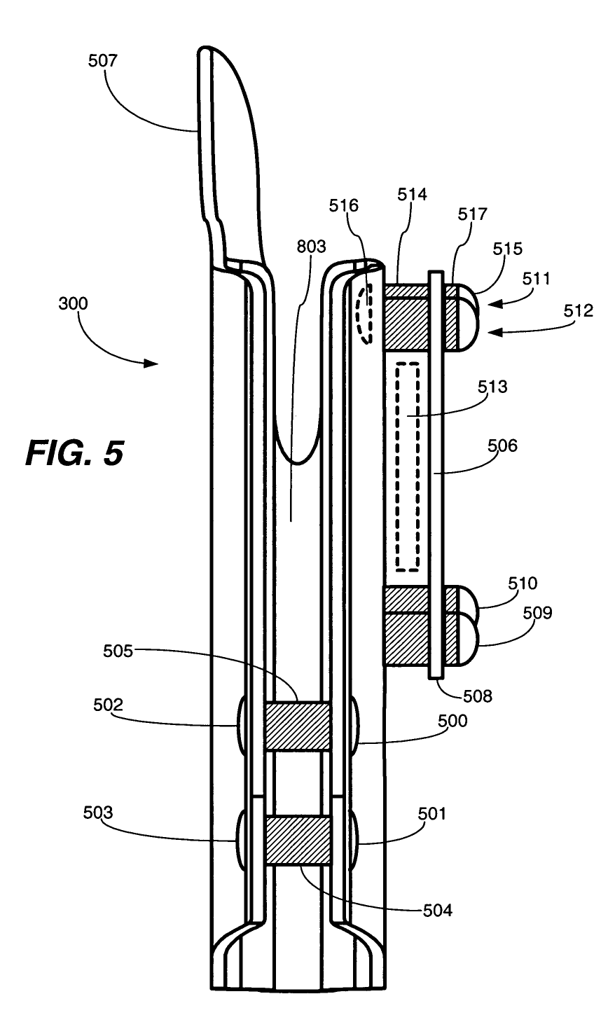

Referring now to FIG. 5, the open portion 803 of the “U” is fastened or closed by at least two fasteners. The fasteners preferably comprise a screw 500,501 inserted into one half of the open end of the “U” 803. A screw boss 502,503 is inserted into the other half of the open end of the “U” 803. The screw 500,501 and screw boss 502,503 are then coupled together. A screw/boss assembly is preferred in that it is adjustable, depending upon the amount of friction from the holding member 301 desired by the user when drawing the firearm. Other means of fastening, including rivets, glues, hot melt joints, welds, plastic, adhesives, stitching and epoxies, however, may also be substituted. Note also that the screw boss 502,503 may be integral to the holding member 301, in that a hole and threads could be designed into the plastic of the holding member 301, thereby eliminating the need for the screw boss.

A bracing member 504,505 may be coupled between the edges of the open end of the “U” shape to provide an opposing force to the screw/boss assemblies. The bracing member 504,505 serves to oppose the compressive forces of the screw 500,501 and boss 502,503. This bracing member 504,505 is preferably a soft rubber grommet that is positioned about the boss 502,503 prior to insertion of the screw 500,501. The soft rubber grommet serves to provide a frictional force against the open halves of the “U”. In one preferred embodiment of the holster assembly 300, two fasteners are included such that the upper fastener formed by elements 500,502,505 may be set to one tension level, while the lower fastener formed by elements 501,503,504 may be set to a second tension level. The plurality of tension levels allows a user to customize the amount to resistance felt when drawing a firearm.

The holding member 301 is coupled to a planar member 506 that is capable of being actuated as a cantilever arm or beam. The planar member 506, sometimes referred to as a “paddle”, is designed to fit over the outside of the belt, while the holster itself fits inside a user's trousers. An anti-snag guard 507 extends from the holding member to prevent the gun or firearm from snagging on a user's clothing. As the holster 300 fits inside the trousers, with the planar member 506 outside the belt, the anti-snag guard 507 presses against the user's shirt, thereby preventing any blousing by the shirt from preventing a quick draw of the firearm.

As stated above, the planar member 506, preferably manufactured from flexible plastic, is designed to operate as a cantilever beam or arm. It is this cantilever action that allows the holster 300 to be quickly decoupled from a user's belt. To decouple the holster 300 from the belt, a user simply grasps the bottom 508 of the planar member 506 with his fingers. The bottom 508 of the planar member 506 extends below a pair of retaining members 509,510 by at least 1/16^{th} of an inch. When the user grasps the bottom 508 of the planar member 506, he is then able to “pry” the bottom 508 of the planar member 506 away from the holding member 301, as the cantilever action allows the planar member 506 to bend in a cantilever fashion. The bending of the planar member 506 allows the retaining members 509,510 to separate from the holding member 301, thereby allowing the holster 300 to be removed from a belt.

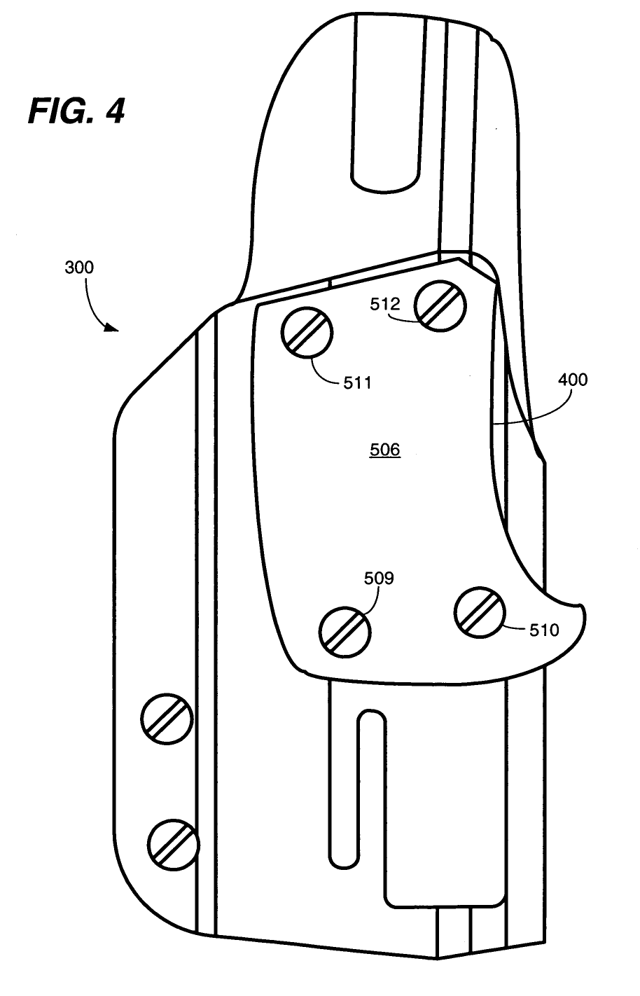

Note when the planar member 506 is not being pulled by a user away from the holding member 301, the planar member 506 preferably preloads the retaining members 509,510 against the holding member 301, thereby allowing the retaining members 509,510, the planar member 506, the holding member 301 and at least two fasteners 511,512 to form a closed loop 513. The at least two fasteners 511,512 (seen more easily in FIG. 4) preferably each comprise a screw boss 516, a screw 515 and a pliable washer 514. An optional washer 517 may be included as well. The fasteners 511, 512 may also comprise any fastener selected from the group consisting of screws, rivets, glues, hot melt joints, welds, plastic, adhesives, stitching and epoxies.

Referring now to FIG. 4, it can be seen that the two fasteners 511,512 are spread across the planar member 506 to ensure stability. The planar member 506 includes at least one concave curvature 400 that allows a belt to flex without binding. The retaining members 509,510 are positioned such that the front retaining member 510 is positioned higher on the planar member 508 than is the rear retaining member 509. While the two retaining members 509,510 may be placed evenly, positioning the front retaining member 510 above the rear retaining member 509 allows the holster 300 to lean forward slightly, the forward lean being seen when looking from top to bottom, to allow the holster to accommodate the shoulder roll that it present when a user draws a firearm from the holster 300. The retaining members 509,510 are spread across the planar member 506 to prevent rotation of the holster 300 while being worn by a user.

Referring now to FIG. 7, the holding member 301 may include the notch aperture 700 mentioned earlier for accommodating the sight of a gun. The notched aperture 700 is disposed on the closed end 701 of the “U” of the holding member 301.

In FIG. 7, the retaining members 509,510 can be seen. As stated above, the retaining members 509,510 extend from the planar member 506 toward the holding member 301. The retaining members 509,510 extend in a perpendicular fashion from the planar member 506, preferably at an angle between 85 and 95 degrees with respect to the planar member 506.

While the retaining members 509,510 may be as simple as a vertical protrusion extending from the planar member 506, in the embodiment shown, the retaining members 509,510 each comprise a screw 702, a screw boss 703 and a frictional member 704 that serves as a means of creating friction against objects like a belt. If a screw boss 703 is not desired, the boss member may be molded into the planar member 506 as an integral component.

The frictional member 704 is preferably manufactured from soft rubber. The soft rubber takes the form of a grommet that encircles the retaining member by encircling the screw boss 703. The frictional member 704, in addition to providing compliance between the screw boss 703 and the planar member 506, provides a frictional force that causes the holster assembly 300 to “cling” to a belt. In so doing, the frictional member 704 prevents a thief or criminal from pulling the holster assembly 300 from a user's personage. The frictional member 704 also prevents the holster assembly 300 from falling off the user's personage in the event that the user falls. The preloading force of the planar member 506 mentioned above ensures that the retaining members 509,510 are securely pressing against the holding member 301 when the holster assembly 300 is at rest.

The holster assembly 300 offers many advantages over the prior art, the foremost of which is easy and quick coupling to a belt. As the retaining members 509,510 are coupled to the planar member, the outer surface of the holding member 301 is smooth and barb free. As such, the holding member 301 may be inserted into a user's trousers without snagging or catching.

To put on the holster assembly 300, a user simply inserts the holding member 301 between his torso and the waistband of his trousers. The user then gently pulls the bottom 508 of the planar member 506 away from the holding member 301. This causes the cantilever planar member 506 to actuate or bend, thereby creating space between the retaining members 509,510 and the holding member 301. This space allows the user to slide the holster assembly 300 down, thereby allowing the retaining members 509,510 to pass over a belt. By releasing the bottom 508 of the planar member 506, the loop formed by the holding member 301, the retaining members 509,510 and the planar member 506 once again closes, thereby securely coupling the holster assembly 300 to the user.

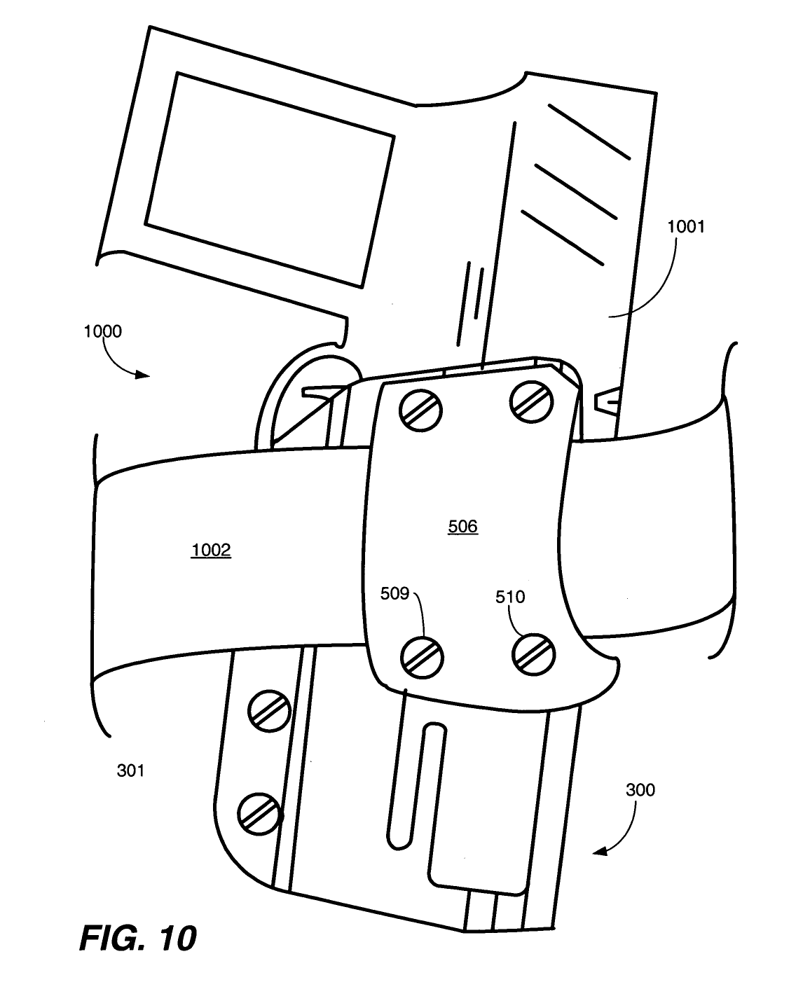

Referring now to FIG. 10, illustrate therein is one application of a holster assembly 300 in accordance with the invention. Shown in FIG. 10 is a firearm assembly 1000 comprising a firearm 1001 and a holster 300. The holster 300 includes the planar member 506, the holding member 301 and the retaining members 509,510. As shown in FIG. 5, the retaining members 509,510, the holding member 301 and the planar member 506 form a closed loop. A belt 1002 passes through this loop, and is positioned such that the holster 300 sits with a forward lean with respect to the belt.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

1. A holster, comprising:
a. a planar member capable of being actuated as a cantilever beam;
b. a holding member coupled to the planar member by at least one fastener;
c. at least two retaining members extending from the planar member towards the holding member, such that when the planar member is not actuated as a cantilever beam, the planar member, the holding member, the at least one fastener and the at least two retaining members form a closed loop;
wherein the at least two retaining members are preloaded against the holding member.

2. The holster of claim 1, further comprising a frictional member coupled to each of the at least two retaining members.

3. The holster of claim 1, wherein the at least two retaining members comprise a front retaining member and a rear retaining member, wherein the front retaining member is positioned higher on the planar member than the rear retaining member.

4. The holster of claim 3, wherein the planar member comprises at least one concave curvature.

5. The holster of claim 1, wherein the planar member is coupled to the holding member by at least two fasteners, wherein the at least two fasteners are selected from the group consisting of screws, rivets, glues, hot melt joints, welds, plastic, adhesives, stitching and epoxies.

6. The holster of claim 5, wherein the holding member is formed from a single piece of material folded in a U-shape so as to accommodate a firearm.

7. The holster of claim 6, wherein the holding member is constructed from a material selected from the group consisting of plastics, styrene, APS, polycarbonates, Kydex, leather, cloth an vinyl.

8. The holster of claim 7, wherein a curved portion of the U-shape comprises a notched aperture for accommodating a sight of the firearm.

9. The holster of claim 8, wherein an open portion of the U-shape accommodates a trigger guard of the firearm.

10. The holster of claim 9, wherein the holding member is molded such that the interior of the U-shape comprises the negative image of the firearm.

11. The holster of claim 10, wherein the open portion of the U-shape is closed by the at least two fasteners, wherein the at least two fasteners are selected from the group consisting of screws, rivets, glues, hot melt joints, welds, plastic, adhesives, stitching and epoxies.

12. The holster of claim 1, wherein the at least two retaining members comprise at least one screw coupled to at least one screw boss.

13. The holster of claim 1, wherein the at least two retaining members each comprise a means for creating friction disposed about the at least two retaining members.

14. The holster of claim 13, wherein the means for creating friction comprise a rubber grommet disposed about the retaining member.

15. The holster of claim 1, wherein the at least two retaining members extend from the planar member at an angle of between 85 and 95 degrees.

16. A firearm assembly, comprising:
a. a firearm;
b. a holster, comprising:
i. a planar member capable of being actuated as a cantilever beam;
ii. a holding member coupled to the planar member by at least one fastener;
iii. at least two retaining members extending from the planar member towards the holding member, such that the planar member, the holding member, the at least one fastener and at least two retaining members form a closed loop; and
iv. a means for creating fiction coupled to the retaining member; and
c. a belt;
wherein the belt is positioned within the space circumscribed by the planar member, the holding member, the at least one fastener and the at least two retaining members.

17. The firearm assembly of claim 16, wherein the planar member is preloaded so as to exert force causing at least one of the at least two retaining members to contact the holding member.

18. The firearm assembly of claim 16, wherein when the holster is coupled to the belt, a front edge of the holster aligns at a non-perpedicular angle with respect to the belt.
